(19) United States
(12) Patent Application Publication
(10) Pub. No.: US 2012/0238690 A1
(43) Pub. Date: Sep. 20, 2012

(54) WATER-BORNE BINDERS FOR PRIMER-SURFACER COATING COMPOSITIONS

(75) Inventors: Roland Feola, Graz (AT); Ulrike Kuttler, Vasoldsberg (AT)

(73) Assignee: Cytec Austria GmbH, Werndorf (AT)

(21) Appl. No.: 13/384,798

(22) PCT Filed: Jul. 21, 2010
(86) PCT No.: PCT/EP2010/060554

§ 371 Date: Jun. 5, 2012

(30) Foreign Application Priority Data
Jul. 21, 2009 (EP) 09166039.9

(51) Int. Cl. C09D 167/02

(52) U.S. Cl. 524/539

(57) ABSTRACT

The invention relates to water-borne coating binders ABC comprising a mixture of a curing agent C and a reaction product AB made by at least partial esterification of a hydroxyl group-containing polyester A and an acid groups-containing polyurethane B, characterised in that each of A and B comprise not more than 20% of the amount of substance of their educts A1, A2, B1, and B2, of molecules comprising aromatic structures, to a method of their preparation, and a method of use thereof to formulate primer-surfacer coating compositions.

### FIELD OF THE INVENTION

This invention relates to water-borne binders for primer-surfacer coating compositions. More specifically, it relates to stoving binders for use in these compositions, and to a process of making these.

### BACKGROUND ART

Stoving binders for primer-surfacer coating compositions, particularly for automotive OEM applications, have been known from the patent literature. Such binders have been described, i. a., in the patents DE 41 42 816 C1, and EP 1 199 342 B1.

In DE 41 42 816 C1, condensation products of carboxyl groups-containing polyurethanes and hydroxyl groups-containing polyesters are described in general terms, while the examples only mention acidic polyurethanes derived from toluoylene diisocyanate, and hydroxyl group-containing polyesters derived from aromatic di- and trifunctional carboxylic acids, viz. isophthalic acid and trimellithic acid. Likewise, in EP 1 199 342 B1, condensation products of carboxyl groups-containing polyurethanes and hydroxyl groups-containing polyesters are described in general terms, while the examples only mention acidic polyurethanes derived from toluoylene diisocyanate, and hydroxyl group-containing polyesters derived from aromatic di- and trifunctional carboxylic acids, viz. isophthalic acid and trimellithic acid.

### SUBJECT OF THE INVENTION

It has been found that such condensation products comprising moieties derived from aromatic educts (starting materials), while providing excellent properties with respect to levelling, hardness, stone chip resistance, and mass fraction of solids in the paint, are prone to embrittlement during stoving, particularly at elevated stoving temperatures, or during prolonged exposure to high temperatures. In the usual processing conditions of car bodies coated with primer-surfacers based on such condensation products, it can not always be excluded that local temperatures, or residence times at elevated temperature, may rise to values higher than appropriate, because fast curing and therefore elevated temperatures are desired, which elevated temperatures accelerate curing. As there is, however, danger of embrittlement upon the application of higher curing temperatures or prolonged exposure to elevated temperatures, the curing process becomes difficult to control.

It is therefore the object of this invention to provide a binder system based on condensation products of carboxyl group-containing polyurethanes and hydroxyl group-containing polyesters that does not show embrittlement upon curing at elevated temperatures, or upon prolonged exposure to elevated temperatures, and which can be cured to a coating film of improved hardness and stone-chip resistance. Curing at elevated temperatures and prolonged exposure to elevated temperatures are collectively referred to as “overbaking” in the technical community. Resistance to overbaking has become one of the primary requirements in OEM car body coating.

This object has been achieved by providing water-reducible, i.e. water-dilutable or water-dispersible, condensation products AB from polyurethanes B having carboxyl groups in their molecules, and hydroxyl groups-containing polyesters A, wherein both A and B comprise, individually, not more than 20% of the amount of substance of their educts of molecules comprising aromatic structures. A molecule is said to comprise an aromatic structure in the context of this invention if it comprises radicals derived from benzene or naphthalene or other aromatic or heteroaromatic molecules, which radicals are obtained by removing at least one hydrogen atom from any said aromatic or heteroaromatic molecule. The condensation products according to the present invention can withstand temperatures of up to 200° C. without embrittlement or other deterioration while preserving the favourable properties of binder resins for primer-surfacers according to the state of the art such as stone-chip resistance, and they also show a reduced propensity to yellowing which is an additional requirement presently having gained attention of car manufacturers due to the trend of using fillers which are formulated in the same colour as the topcoat. This has grown particularly important for light car body colours.

### DETAILED DESCRIPTION OF THE PREFERRED EMBODIMENTS

It is also preferable, in accordance with the present invention, to use curing agents C which are selected from the group consisting of capped aliphatic or cycloaliphatic polyfunctional isocyanates C1 and from aminoplast resins C2, particularly those having a high degree of alkylolation, particularly, methylolation, or alkoxyalkylation, expressed as the ratio of the amount of substance of N-alkylol groups or N-alkoxyalkyl groups, n(-N—CHR—OR′) where R and R′ may independently be H, or linear or branched alkyl having from 1 to 8 carbon atoms, and R may also be the residue of an oxo compound having from 1 to 8 carbon atoms, to imino groups, n(-NH—), of at least 5 mol/1 mol. Particularly preferably, this ratio is at least 5.2, and most preferred, at least 5.3. Residue in the context of this invention means an organic monovalent radical obtained by removing one hydrogen atom from an organic compound. Particularly preferred is the use of hexamethyoxyalkyl or hexamethoxymethyl melamine.

It is also possible to use an alkoxycarbonylaminotriazine C3 as crosslinker, such as tris-butoxycarbonylaminotriazine, optionally in combination with crosslinkers C2. Especially good results have been obtained with purely aliphatic or cycloaliphatic polyfunctional isocyanates C1, or with mixtures of two or more polyfunctional isocyanates comprising a mass fraction of not more than 10% of such polyfunctional isocyanates that comprise an aromatic structure.

In the context of the present invention, it is preferred to use exclusively, or to an extent corresponding to a mass fraction of at least 80%, particularly preferably of 90% or more, of the crosslinkers used, purely aliphatic or cycloaliphatic polyfunctional isocyanates.

In the synthesis of the condensation products AB, it is preferred to react components A and B in a mass ratio m(A):m(B) of from 90:10 to 30:70. Synthesis of such condensation products AB is preferably conducted by esterifying the hydroxyl groups-containing polyester A and the carboxylic acid groups-containing polyurethanes B at a temperature of from 90° C. to 160° C., preferably under removal of the water formed in the condensation reaction, until the condensation product AB has reached a value of the Staudinger index of preferably from 10 cm³/g to 20 cm³/g, and an acid number of preferably from 30 mg/g to 50 mg/g. After at least partial neutralisation of the remaining carboxyl groups (under con-version of approximately from 50% to 100% of these acid groups to acid anion groups), the condensation products AB are dispersible in water.

A substance is referred to as being “dispersible in water” in the context of this invention if a dispersion in water of the said substance with a mass fraction of that said substance in the dispersion of up to 40% exhibits no phase separation after storage of that dispersion at room temperature (21° C.) for a period of six weeks.

The condensation products AB preferably comprise a mass fraction of at most 10% of aromatic moieties, this mass fraction being calculated by dividing the sum of the masses or aromatic (mono-, di- or poly-)radicals in the condensation product AB (such as, in the case of terephthalic acid, the residue C₆H₄) by the total mass of the condensation product AB, particularly preferably a mass fraction of at most 7%, and especially preferred, of at most 5%. The best results have been realised when the mass fraction of aromatic moieties did not exceed 2%.

Useful polyester resins A are made in a known manner by polycondensation of multi-functional alcohols A1 and multifunctional acids A2, where at least a part of these may be replaced by hydroxy acids A21. Kind and amounts of educts A1, A2, and A21 have to be chosen in a way that the reaction products, viz., the polyesters A, have a sufficient number of hydroxyl groups (for later reaction with the curing agent).

Preferably, the hydroxyl number of these polyesters A is from 50 mg/g to 500 mg/g. The desired acid number of these polyesters A is preferably from 15 mg/g to 80 mg/g, particularly preferably from 20 mg/g to 50 mg/g. Their Staudinger index is preferably from 5 cm³/g to 15 cm³/g, particularly preferred from 7 cm³/g to 13 cm³/g.

Only selected aliphatic or cycloaliphatic alcohols having at least two hydroxyl groups and from 2 to 20 carbon atoms per molecule may preferably be used as alcohols A1, particularly preferably 1,4-butanediol, 1,2-butanediol, 1,3-propanediol, 1,2-propanediol, 1,6-hexanediol, 1,2- or 1,4-dimethylol cyclohexane, trimethylol propane, and pentaerythritol. It is preferred to use aliphatic or cycloaliphatic alcohols having two hydroxyl groups; a mass fraction of up to 10% of the alcohols may, however, have three or more hydroxyl groups.

Only selected aliphatic or cycloaliphatic acids having at least two acid groups and from 2 to 20 carbon atoms per molecule may preferably be used as polyfunctional acids A2, the following carboxylic acids having proved to be particularly suited as polyfunctional acids A2: adipic acid, glutaric acid, succinic acid, 1,2-, 1,3-, and 1,4-cyclohexanedicarboxylic acid, hexahydrophthalic anhydride, as well as aliphatic hydroxy acids such as lactic acid, hydroxybutyric acid, hydroxyvaleric acid, hydroxy caproic acid, hydroxy- and dihydroxy-succinic acid.

The polyurethanes B preferably have a Staudinger index of from 5 cm³/g to 15 cm³/g, particularly preferably from 7 cm³/g to 12 cm³/g. Their hydroxyl number is preferably from 0 mg/g to 110 mg/g, and particularly preferably up to 90 mg/g. Their acid number is preferably from 50 mg/g to 180 mg/g, particularly preferably from 60 mg/g to 150 mg/g.

Carboxy functional polyurethane resins B can be prepared by reaction of selected aliphatic monoalcohols (chain stoppers) B1, and selected aliphatic and cycloaliphatic diols (chain extenders) B2, hydroxyalkanoic acids B31 having one carboxylic acid group and one hydroxyl group (chain stoppers) such as 4-hydroxybutyric acid, or two or more hydroxyl groups (dihydroxyalkanoic acids B32, such as dimethylol propionic acid, chain extenders). Among the latter, it is preferred to use dihydroxymonocarboxylic acids such as dimethylol acetic acid, dimethylol propanoic and butyric acids. Further reactants include polyfunctional isocyanates B4 which are preferably exclusively cycloaliphatic, such as isophorone diisocyanate, bis(4-isocyanatomethyl)-cyclohexane, bis(4-isocyanatocyclohexyl)-methane (e.g., ®Desmodur W, Bayer Material Science AG).

The alcohols are preferably selected from the group consisting of aliphatic and cycloaliphatic monoalcohols B1 having from 1 to 14 carbon atoms such as methoxyethanol, 4-methoxybutanol, and 2-ethylhexanol, diethylene glycol monoethyl ether, diethylene glycol monobutyl ether, triethylene glycol monoethyl ether, triethylene glycol monobutyl ether, hexanol and homologues thereof, and diols B2 having from 2 to 1000 carbon atoms such as 1,2-propanediol, 1,2-butanediol, 1,4-butanediol, 1,2- and 1,4-dimethylol cyclohexane, 1,6-hexanediol, aliphatic polycarbonate diols, aliphatic polyester diols as known in the art, aliphate polyamide diols, and polycaprolactone diols (®Placcel 500 series, IMCD Group B.V.).

The condensation product AB is made in an esterification reaction wherein carboxyl groups of the polyurethane component B react with hydroxyl groups of the polyester component A in an esterification reaction, under formation of water, and formation of an ester bond between two molecules of components A and B. The condensation product preferably has an acid number of from 15 mg/g to 60 mg/g, with particular preference of from 20 mg/g to 40 mg/g, and a hydroxyl number of from 100 mg/g to 250 mg/g, with particular preference of from 150 mg/g to 200 mg/g. The condensation reaction can be accelerated if the water formed in the esterification reaction is removed from the reaction mixture by an entrainment agent. Another possibility is to form reaction products of the hydroxyl groups-containing polyester A and the carboxyl groups-containing polyurethane if the latter is made from a mixture of polyfunctional isocyanates and partially half-capped isocyanates, thereby generating a polyurethane B that has carboxyl groups derived from the hydroxyalkanoic acids, and capped isocyanate groups derived from the partially capped polyfunctional isocyanates. Components A and B can the be reacted under formation of a urethane bond and removal of the capping agent, under formation of a urethane-coupled reaction product AB.

The invention is further illustrated by the following examples which are not to be construed as limiting.

In the examples, as well as in the introductory portion of the specification, the following standards are used:

The acid number is defined, according to DIN EN ISO 3682 (DIN 53 402), as the ratio of that mass m_{KOH} of potassium hydroxide which is needed to neutralise the sample under examination, and the mass m_{B} of this sample, or the mass of the solids in the sample in the case of a solution or dispersion; its customary unit is “mg/g”.

The hydroxyl number is defined according to DIN EN ISO 4629 (DIN 53 240) as the ratio of the mass of potassium hydroxide m_{KOH} having the same number of hydroxyl groups as the sample, and the mass m_{B} of that sample (mass of solids in the sample for solutions or dispersions); the customary unit is “mg/g”.

The molar mass of a substance is denoted by the usual symbol M, its SI unit is “kg/mol” or customary multiples thereof.

The physical quantity formerly referred to as “limiting viscosity number”, properly named “Staudinger-Index” J_{g} according to DIN 1342, part 2.4, is the limiting value of the Staudinger function Jᵥ for decreasing concentration and shear gradient, wherein Jᵥ stands for the relative change in viscosity divided by the mass concentration β_{B}=m_{B}/V of the solute B (having a mass m_{B} of the solute in a volume V of the solution), viz., Jᵥ=(ηᵣ−1)/β_{B}. The relative change in viscosity ηᵣ−1 is calculated as ηᵣ−1=(η−ηₛ)/ηₛ. The relative viscosity ηᵣ is the ratio of the viscosity η of the solution under consideration, and the viscosity ηₛ of the pure solvent. The physical significance of the Staudinger index is that of a specific hydrodynamic volume of the solvated polymer coils at infinite dilution in the state of rest. The unit generally accepted for J is “cm³/g”; formerly often “dl/g”. The solvent employed in these examples is dimethyl formamide.

### EXAMPLES

### Example 1

### Preparation of the Hydroxy Functional Polyester Aa

34.2 g (0.45 mol) of 1,2-propanediol, 11.8 g (0.10 mol) of 1,6-hexanediol, 13.4 g (0.10 mol) of trimethylolpropane, 21.9 g (0.15 mol) of adipic acid, 25.9 g (0.17 mol) of tetrahydrophthalic anhydride and 9.6 g (0.05 mol) of trimellithic anhydride were charged into a three-neck glass vessel equipped with a stirrer and a reflux condenser. This mixture was heated to 210° C. with a rate of 10 K/h under a nitrogen blanket. Esterification was continued with separation of the water formed until an acid number of less than 25 mg/g was reached. The Staudinger index measured in a solution of N,N-dimethylformamide at 23° C. was 11.5 cm³/g. A hydroxyl number of 341 mg/g was determined on a sample drawn.

The composition of further polyesters made in accordance with this procedure is listed in table 1. Polyester Ag is a comparative product having lower acid number than claimed (14 mg/g). The following abbreviations are used:

BG: ethylene glycol butyl ether DMBS: dimethylolbutyric acid
EG: ethylene glycol ethyl ether HBS: 4-hydroxybutyric acid
BD: 1,4-butanediol APS: adipic acid
CHD: 1,4-dimethylolcyclohexane THPSA: tetrahydrophthalic anhydride
HEX: 1-hexanol TMSA: trimellithic anhydride
CLD: polycaprolactonediol 550 (M=550 g/mol) BSS: succinic acid
PD: 1,2-propanediol HHPSA: hexahydrophthalic anhydride
HD: 1,6-hexanediol CHDS: 1,4-cyclohexanedicarboxylic acid
TMP: trimethylolpropane IPDI: isophorone diisocyanate
NPG: neopentyl glycol HDI: hexamethylene diisocyanate
PY: pentaerythritol BICM: bis(4-isocyanatocyclohexyl)methane
DMPS: dimethylolpropionic acid BIMC: bis(4-isocyanatomethyl)cyclohexane

TABLE 1
Polyesters Aa to Af and Ag (Comparison)

| | | | Water formed | Yield of solid resin | Staudinger index | Hydroxyl number | Acid number in |
|---|---|---|---|---|---|---|---|
| Polyester | Alcohols* | Acids* | in mol\|g | in g | in cm³/g | in mg/g | mg/g |
| Aa | PD\|0.45\|34.2 | APS\|0.15\|21.9 | 0.52\|9.3 | 107.5 | 11.5 | 341 | 25 |
| | HD\|0.1\|11.8 | THPSA\|0.17\|25.9 | | | | | |
| | TMP\|0.1\|13.4 | TMSA\|0.05\|9.6 | | | | | |
| Ab | NPG\|0.3\|31.2 | APS\|0.16\|23.4 | 0.74\|13.3 | 97.7 | 12.7 | 194 | 22 |
| | PG\|0.1\|7.6 | IPS\|0.16\|26.6 | | | | | |
| | TMP\|0.1\|13.4 | TMSA\|0.05\|9.6 | | | | | |
| Ac | BD\|0.31\|27.9 | BSS\|0.1\|11.8 | 0.39\|7.0 | 97.6 | 7.5 | 343 | 30 |
| | PG\|0.1\|7.6 | HHPSA\|0.25\|38.5 | | | | | |
| | TMP\|0.14\|18.8 | | | | | | |
| Ad | HD\|0.3\|35.4 | BSS\|0.12\|14.2 | 0.39\|7.0 | 107.4 | 7.3 | 325 | 34 |
| | CHD\|0.12\|17.3 | HHPSA\|0.22\|33.9 | | | | | |
| | PY\|0.1\|13.6 | | | | | | |
| Ae | HD\|0.42\|49.6 | APS\|0.07\|10.1 | 0.49\|8.8 | 105.6 | 8.5 | 127 | 24 |
| | TMP\|0.05\|6.7 | HHPSA\|0.25\|38.5 | | | | | |
| | | TMSA\|0.05\|9.6 | | | | | |
| Af | HD\|0.32\|37.8 | CHDS\|0.15\|25.8 | 0.59\|10.6 | 105.3 | 9.1 | 322 | 30 |
| | PD\|0.1\|7.6 | APS\|0.15\|21.9 | | | | | |
| | TMP\|0.12\|16.1 | DMPS\|0.05\|6.7 | | | | | |
| Ag | HD\|0.3\|35.4 | BSS\|0.12\|14.2 | 0.43\|7.7 | 106.7 | 9.5 | 309 | 14 |
| | CHD\|0.12\|17.3 | HHPSA\|0.22\|33.9 | | | | | |
| | PY\|0.1\|13.6 | | | | | | |

*kind | amount of substance in mol | mass in g

### Example 2

### Preparation of the Carboxy-Functional Polyurethane Ba

A mixture of 670 g (5.0 mol) of dimethylolpropionic acid and 1300 g of N-methylpyrrolidone was heated under stirring to 110° C. A reaction product of 1572 g (6.0 mol) of bis(4-isocyanatocyclohexyl)methane and 236 g (2.0 mol) of ethylene glycol monobutyl ether having a mass fraction of isocyanate groups m (NCO)/m=23.3% where m is the mass of the reaction product, and m(NCO) is the mass of isocyanate groups, was added to the solution formed within two hours. The reaction mass was held at 110° C. for a further two hours to complete the reaction of the isocyanate groups until no more isocyanate groups could be detected, and was then diluted with N-methylpyrrolidone to a mass fraction of solids of 60%. The product obtained had an acid number of 113 mg/g and a Staudinger index of 10.9 cm³/g as measured in N,N-dimethylformamide at 23° C.

The composition of further polyurethanes made in accordance with this procedure is listed in table 2.

TABLE 2
Polyurethanes Ba to Bf

| Poly- | | | | Yield of | Staudinger | Hydroxyl | Acid |
|---|---|---|---|---|---|---|---|
| ure- | | | | solid resin | index | number | number |
| thane | Alcohols* | Acids* | Diisocyanate* | in g | in cm³/g | in mg/g | in mg/g |
| Ba | BG\|2.0\|236 | DMPS\|5.0\|670 | BICM\|6.0\|1572 | 2478 | 10.9 | 0 | 113 |
| Bb | EG\|1.0\|90 | DMBS\|2.0\|296 | IPDI\|3.0\|666 | 1142 | 6.6 | 49 | 98 |
| | BD\|1.0\|90 | | | | | | |
| Bc | BD\|2.0\|180 | DMPS\|1.5\|201 | IPDI\|3.0\|666 | 1322 | 7.8 | 85 | 63 |
| | CLD\|0.5\|275 | | | | | | |
| Bd | HEX\|0.5\|51 | DMPS\|5.0\|670 | BIMC\|6.0\|1164 | 2020 | 9.8 | 41 | 139 |
| | BD\|1.5\|135 | | | | | | |
| Be | EG\|2.0\|180 | DMPS\|2.0\|268 | HDI\|2.0\|336 | 1575 | 8.5 | 0 | 71 |
| | CHD\|0.5\|72 | | IPDI\|2.9\|444 | | | | |
| | CLD\|0.5\|275 | | | | | | |
| Bf | EG\|1.0\|90 | HBS\|1.0\|104 | IPDI\|3.0\|666 | 1219 | 7.2 | 0 | 92 |
| | CHD\|0.8\|115 | DMPS1.0\|134 | | | | | |
| | CLD\|0.2\|110 | | | | | | |

### Example 3

### Preparation of Condensation Products AB

Polyesters A from Example 1 and polyurethanes B from Example 2 were mixed according to the mass ratios listed in table 3, and held at 160° C. for a time sufficient to reach both the desired Staudinger index of from 10 cm³/g to 20 cm³/g, and an acid number of from 30 mg/g to 50 mg/g. The reaction mass was checked from time to time by partially (consumption of about 80% of the acid groups) neutralising a sample drawn with diethanolamine, and checking for miscibility with water (water-miscible means that there is no phase separation after 30 days of storage of a solution or dispersion diluted to a mass fraction of solids of about 10%).

In a case where the acid number of the polyester A alone is already in excess of 20 mg/g, a condensation reaction with the polyurethane is not always needed, simply mixing the polyester A with the polyurethane B suffices for water dispersibility. However, if long shelf life such as in excess of three months, and good stone chip resistance are desired, it is advisable to increase the molar mass of the binder resin by a condensation step.

The general procedure to formulate a binder dispersion comprises to charge a mass fraction of from 80% to 60%, based on the mass of the resulting binder dispersion, of the condensation product AB, to heat this charge to from 100° C. to 120° C., and to intimately mix this with a mass fraction of from 20% to 40% of a crosslinker, such as a commercially available multifunctional isocyanate capped with butanonoxime (®Desmodur N 3300, Bayer Material Science AG), and then neutralising at least 50% of the acid groups remaining by addition of dimethylethanolamine. The mixture thus obtained is then diluted by addition of desalinated water to a viscosity of less or about 2000 mPa·s measured at 23° C. This usually corresponds to a mass fraction of solids in the aqueous dispersion of from 35% to 45%.

It is also possible to make a binder dispersion without premature admixing of a crosslinker, by neutralising the condensation products and diluting the neutralised condensation products with water to the desired viscosity. In this case, a crosslinker is added later when making the paint (in the usual way by adding pigments, fillers, additives and preservatives, etc.), preferably a water-reducible amino resin (e.g., a melamine formaldehyde resin) or a water-soluble capped multifunctional isocyanate.

Experience has shown that in those cases where the acid number of the polyester A had been less than 20 mg/g, it had been difficult to reproducibly reach and exceed the desired minimum acid number of 30 mg/g for the condensation product AB. This had led to problems in the storage stability of binder resin dispersions and also paints based on such condensation products, particularly in combination with water-insoluble capped isocyanate crosslinkers. Therefore, every effort has been made to have an acid number of from 20 mg/g to 40 mg/g for the polyester A to ensure that the desired range for the acid number of the condensation product AB of from 30 mg/g to 50 mg/g is always reached.

TABLE 3
Preparation of Condensation Resins AB

| | | | Condensation | | | | | |
|---|---|---|---|---|---|---|---|---|
| | Polyester A | Polyurethane B | Product AB | | | mass | | mass fraction |
| | mass fraction | mass fraction | Acid Number in | Crosslinker | Viscosity | fraction | | of aromatic |
| Binder | in % | in % | mg/g \|Staudinger | mass fraction in | at 23° C. | of solids | Storage | moieties |
| Resin | \|Designation | \|Designation | Index in cm³/g | % \|Designation | in mPa · s | in % | Stability* | in % |
| BM 1 | 80 \| Aa | 20 \| Ba | 36 \| 12.8 | 43 \| H 1 | 1530 | 38.5 | OK | 7.1 |
| BM 2 | 70 \| Ab | 20 \| Bb | 32 \| 15.3 | 25 \| H 1 | 710 | 40.9 | OK | 6.9 |
| BM 3 | 75 \| Ac | 25 \| Ba | 43 \| 13.8 | 25 \| H 2 | 1205 | 44.3 | OK | 0 |
| BM 4 | 70\| Ae | 30\| Bc | 31 \| 11.8 | 25 \| H 2 | 364 | 42.5 | OK | 6.4 |
| BM 5 | 75 \| Ad | 25 \| Bd | 34 \| 13.2 | 34 \| H 1 | 1446 | 43.5 | OK | 0 |
| BM 6 | 75 \| Af | 25 \| Bb | 36 \| 14.8 | none | 1241 | 42 | OK | 0 |
| BM 7 | 80 \| Ac | 20 \| Ba | 35 \| 13.6 | none | 806 | 44.8 | OK | 0 |
| BM 8 | 80 \| Ad | 20 \| Bd | 45 \| 13.3 | none | 577 | 41.2 | OK | 0 |
| Comparative Examples: | | | | | | | | |
| VB 1 | 70 \| PE 1 | 30 \| PU 1 | 37 \| 16.0 | 54 \| H 1 | 320 | 35 | OK | 40.4 |
| VB 2 | 77 \| PE 2 | 23 \| PU 2 | 35 \| 15.8 | 43 \| H 2 | 270 | 34 | OK | 37.4 |
| BM 9 | 80 \| Ag | 20 \| Bd | 28 \| 13.5 | none | 407 | 39.3 | slight | 0 |
| | | | | | | | settling | |
| BM 10 | 75 \| Ag | 25 \| Bd | 23 \| 13.4 | 34 \| H 1 | 298 | 40.5 | strong | 0 |
| | | | | | | | settling | |

*measured on 10% strength solution in water

### Comparative Examples

PE 1: is the polyester component B2 of EP 0 594 685 B1, amount-of-substance fraction of aromatic educts is 34.8
PE 2: is the polyester component B4 of EP 0 594 685 B1, amount-of-substance fraction of aromatic educts is 32.5
PU 1: is the polyurethane component A2 of EP 0 594 685 B1, amount-of-substance fraction of aromatic educts is 53.3
PU 2: is the polyurethane component A1 of EP 0 594 685 B1, amount-of-substance fraction of aromatic educts is 53.8
VB 1: corresponds to Example 2 of table 2 of EP 0 594 685 B1
VB 2: corresponds to Example 4 of table 2 of EP 0 594 685 B1
H1: commercial polyfunctional trimeric hexamethylene diisocyanate having an isocyanurate structure capped with butanone oxime (®Desmodur N 3390, Bayer Materials Science)
H2: commercial polyfunctional trimeric hexamethylene diisocyanate having a biuret structure (®Desmodur N 100, Bayer Materials Science)

### Example 4

### Test of the Binders in Filler-Surfacer Paints for Automotive Applications Aqueous Filler-Surfacer Paints have been Made from the Binders of Table 3 According to the Formulations of Table 4

TABLE 4
Paint Compositions (masses of all components in g)

| | Paint | Paint | Paint | Paint | Paint | Paint | Paint | Paint | Paint | Paint |
|---|---|---|---|---|---|---|---|---|---|---|
| | 1 | 2 | 3 | 4 | 5 | 6 | 7 | 8 | 9 | 10 |
| BM 1 | 109.1 | | | | | | | | | |
| BM 2 | | 102.7 | | | | | | | | |
| BM 3 | | | 94.8 | | | | | | | |
| BM 4 | | | | 98.8 | | | | | | |
| BM 5 | | | | | 96.5 | | | | | |
| BM 6 * | | | | | | 100 | | | | |
| BM 7 * | | | | | | | 93.75 | | | |
| BM 8 * | | | | | | | | 101.9 | | |
| VB1 | | | | | | | | | 120 | |
| VB2 | | | | | | | | | | 123.5 |
| Wetting Agent | 1.2 | 1.2 | 1.2 | 1.2 | 1.2 | 1.2 | 1.2 | 1.2 | 1.2 | 1.2 |
| (Surfynol 104E) | | | | | | | | | | |
| Deionised Water 1 | 9 | 7 | 8 | 5 | 8 | 9 | 5 | 6 | 5 | 5 |
| Pigment (TiO2, | 60 | 60 | 60 | 60 | 60 | 60 | 60 | 60 | 60 | 60 |
| ®Kronos 2190) | | | | | | | | | | |
| Filler + | 60 | 60 | 60 | 60 | 60 | 60 | 60 | 60 | 60 | 60 |
| BM 1 | 202.6 | | | | | | | | | |
| BM 2 | | 190.7 | | | | | | | | |
| BM 3 | | | 176 | | | | | | | |
| BM 4 | | | | 183.5 | | | | | | |
| BM 5 | | | | | 179.3 | | | | | |
| BM 6 * | | | | | | 128.6 | | | | |
| BM 7 * | | | | | | | 120.5 | | | |
| BM 8 * | | | | | | | | 131.1 | | |
| VB1 | | | | | | | | | 222.8 | |
| VB2 | | | | | | | | | | 229.4 |
| Curing Agent § | | | | | | 24 | 24 | 24 | | |
| Deionised Water 2 | 14 | 10 | 12 | 8 | 13 | 9 | 7 | 9 | 8 | 7 |
| Mass of Paint | 455.9 | 431.6 | 412 | 416.5 | 418 | 391.8 | 371.5 | 393.2 | 477 | 486.1 |
| in g | | | | | | | | | | |

* no curing agent
§ Aminoplast Curing Agent (Hexamethoxymethyl-Melamine Type)
+ Filler (Barium Sulphate; average particle size 1 μm)

Using the formulations of table 4, pigmented pastes were at first produced in the usual way charging the binders, wetting agent, deionised water (1), pigment and filler, and homogenising the mixture thus obtained in a bead mill, and then completing the paint by adding more binder, curing agent, and portion (2) of deionised water. This latter portion of water was chosen to obtain a viscosity of the final paint of approximately 120 mPa·s. Paints 1 to 10 were applied using a 150 μm doctor blade on clean glass plates and were dried after an initial flash off during fifteen minutes as follows:
for twenty minutes at 165° C. (stoving procedure 1, denoted as ⁽¹⁾ in table 5)
for thirty minutes at 190° C. (stoving procedure 2, denoted as ⁽²⁾ in table 5).

The coatings thus obtained were tested for pendulum hardness and gloss, the paint films were also judged by visual inspection.

The results of the paint testing are summarised in Table 5:

| | Pendulum | Pendulum | | |
|---|---|---|---|---|
| Paint | Hardness in s ⁽¹⁾ | Hardness in s ⁽²⁾ | Gloss ⁽¹⁾ | Gloss ⁽²⁾ |
| 1 | 97 | 105 | 90 | 83 |
| 2 | 98 | 105 | 90 | 86 |
| 3 | 101 | 110 | 91 | 91 |
| 4 | 97 | 106 | 91 | 87 |
| 5 | 105 | 113 | 91 | 91 |
| 6 | 100 | 107 | 90 | 90 |
| 7 | 98 | 105 | 92 | 92 |
| 8 | 102 | 110 | 90 | 90 |
| 9 | 86 | 111 | 91 | 82 |
| 10 | 83 | 115 | 92 | 83 |

All filler coating compositions yield cured coating films having surface free from defects and had dry film thicknesses of 35 μm±0.5 μm. For paints 1, 2 and 4, there was a slight loss in gloss if the paint films were exposed to higher temperatures, or for longer times. This was most marked in paint 1 having the highest aromatic content. Coating films made from paints 1 to 8 according to the invention already developed better hardness at the lower stoving temperature (condition ⁽¹⁾). Gloss values did not change in the coating films made with binders according to the invention for different stoving conditions 1 and 2 with no aromatic content (paints 3 and 5 to 8), while gloss was reduced markedly in the systems using the comparative filler binders 9 and 10 when stoving was made at the higher temperature ⁽²⁾.

In a further comparative test, test metal sheets were subjected to a stone chip resistance test. Commercial bonder steel sheets (Bonder 26 60° C.) were coated with (dry thickness in all cases) 25 μm of a commercial CED coating (the same in all cases), a 35 μm layer of the aqueous filler of paints 1 to 10, and a 40 μm layer of a commercial acrylic, melamine resin crosslinked top coat (the same in all cases). Stoving conditions for these layers were:

| | |
|---|---|
| CED | thirty minutes, 175° C. |
| Filler, condition 1 | twenty minutes, 165° C. |
| Filler, condition 2 | thirty minutes, 190° C. |
| top coat | thirty minutes, 140° C. |

After the last stoving step, the coated bonder sheets were stored in standard climate (DIN EN 23270, temperature (23±2)° C., relative humidity (50±5) %) for twenty-four hours, and then subjected to a stone chip test according to DIN 55 996-1 (ISO 20577-2:2005) with two runs of 0.5 kg of edged stone grit at an air pressure of 2 bar (0.2 MPa) at the same standard climate conditions. The results are listed below in Table 6:

TABLE 6
Results of the Stone Chip Test

| | Paint No. | | Stone Chip Test |
|---|---|---|---|
| | from | Stoving | Rating according |
| | Table 4 | Condition | to DIN 55996-1 Standard |
| Test Steel Sheet 1 | 1 | 1 | 0 to 1 |
| Test Steel Sheet 2 | 1 | 2 | 1 |
| Test Steel Sheet 3 | 2 | 1 | 1 |
| Test Steel Sheet 4 | 2 | 2 | 1 |
| Test Steel Sheet 5 | 3 | 1 | 1 |
| Test Steel Sheet 6 | 3 | 2 | 1 |
| Test Steel Sheet 7 | 4 | 1 | 0 to 1 |
| Test Steel Sheet 8 | 4 | 2 | 0 to 1 |
| Test Steel Sheet 9 | 5 | 1 | 0 to 1 |
| Test Steel Sheet 10 | 5 | 2 | 1 |
| Test Steel Sheet 11 | 6 | 1 | 0 to 1 |
| Test Steel Sheet 12 | 6 | 2 | 1 |
| Test Steel Sheet 13 | 7 | 1 | 1 |
| Test Steel Sheet 14 | 7 | 2 | 1 to 2 |
| Test Steel Sheet 15 | 8 | 1 | 1 |
| Test Steel Sheet 16 | 8 | 2 | 1 to 2 |
| Test Steel Sheet 17 | 9 | 1 | 1 |
| Test Steel Sheet 18 | 9 | 2 | 4 to 5 |
| Test Steel Sheet 19 | 10 | 1 | 0 to 1 |
| Test Steel Sheet 20 | 10 | 2 | 3 to 4 |

Test sheets 17 and 18 were made with binder VB 1 (corresponding to Example 2 of table 2 of EP 0 594 685 B1), and sheets 19 and 20 with binder VB 2 (corresponding to Example 4 of table 2 of EP 0 594 685 B1). These comparative test sheets showed a marked dependence in stone chip resistance upon the curing temperature: while at the lower temperature, the observed stone chip resistance was on par with those measured with the binders of the invention, exposure to higher temperature gave unsatisfactory results. This shows clearly the advantage brought about by the invention.

1-12. (canceled)

13. A water-borne coating binder ABC comprising a mixture of a curing agent C selected from the group consisting of capped isocyanates C1 based on aliphatic isocyanates, and aminoplast curing agents C2, and a reaction product AB made by at least partial esterification of a hydroxyl group-containing polyester A and an acid groups-containing polyurethane B, wherein the polyesters A are made by polyesterification of aliphatic linear branched or cyclic alcohols A1 which are at least difunctional, and of aliphatic linear branched or cyclic carboxylic acids A2 which are at least difunctional, wherein the amounts of A1 and A2 subjected to polyesterification are chosen in a way that the sum n(OH) of the amounts of substance of alcoholic hydroxyl groups in A1 and the sum n(H) of the amounts of substance of acidic hydrogen groups in the acids A2 are in a ratio n(OH):n(H) of from 1.08 to 1.01, and wherein the polyurethane B is made by polyaddition of isocyanate-functional compounds B1 having an average isocyanate functionality of more than one, and of hydroxy functional compounds B2 having an average hydroxyl functionality of more than 1, and wherein at least a mass fraction of 20% of the compounds B2 are such compounds B21 which have at least one acid group that is less reactive towards isocyanate groups than the hydroxyl groups of the said compounds B21, wherein each of A and B comprise not more than 20% of the amount of substance of their educts A1, A2, B1, and B2, of molecules comprising aromatic structures.

14. The water-borne coating binder of claim 13, wherein the polyester A has a hydroxyl number of from 100 mg/g to 500 mg/g, and an acid number of from 15 mg/g to 50 mg/g.

15. The water-borne coating binder of claim 13, wherein the polyurethane B has an acid number of from 50 mg/g to 180 mg/g.

16. The water-borne coating binder of claim 13, wherein the alcohols A1 are aliphatic linear branched or cyclic alcohols having two hydroxyl groups and from 2 to 10 carbon atoms.

17. The water-borne coating binder of claim 13, wherein the carboxylic acids A2 are aliphatic linear branched or cyclic dicarboxylic acids having from 3 to 10 carbon atoms.

18. The water-borne coating binder of claim 13, wherein in the condensation of the polyesters A, linear, branched or cyclic hydroxycarboxylic acids A12 are also used, selected from the group consisting of hydroxyacetic acid, 2-hydroxypropionic acid, 3-hydroxypropionic acid, 4-hydroxybutyric acid, 5-hydroxyvaleric acid, 6-hydroxycaproic acid, their chain-branched methylated and ethylated homologues, and 2-, 3- and 4-hydroxymethyl cyclohexanecarboxylic acids.

19. The water-borne coating binder of claim 13, wherein in the synthesis of the polyurethane B, the compounds B21 are dihydroxycarboxylic acids having from 4 to 12 carbon atoms and one or two carboxylic acid groups.

20. The water-borne coating binder of claim 19, wherein the compounds B21 are selected from the group consisting of dimethylol acetic acid, dimethylol propionic acid, and dimethylol butyric acid.

21. The water-borne coating binder of claim 13, wherein the isocyanate-functional compounds B1 are selected from the group consisting of tetramethylene-1,4-diisocyanate, hexamethylene-1,6-diisocyanate, 1,4-diisocyanatocycloxane, bis-(4-isocyanatocyclohexyl)-methane, isophorone diisocyanate, bis(4-isocyanatocyclohexyl)methane, and bis(4-isocyanato-methyl)cyclohexane.

22. A process to make the water-borne coating binder of claim 13, wherein in separate reactions,
preparing a hydroxyl group-containing polyester A by polyesterification of aliphatic linear branched or cyclic alcohols A1 which are at least difunctional, and of aliphatic linear branched or cyclic carboxylic acids A2 which are at least difunctional, wherein the amounts of A1 and A2 subjected to polyesterification are chosen in a way that the sum n(OH) of the amounts of substance of alcoholic hydroxyl groups in A1 and the sum n(H) of the amounts of substance of acidic hydrogen groups in the acids A2 are in a ratio n(OH):n(H) of from 1.08 to 1.01, and
making an acid groups-containing polyurethane B by polyaddition of isocyanate-functional compounds B1 having an average isocyanate functionality of more than one, and of hydroxy functional compounds B2 having an average hydroxyl functionality of more than 1, and wherein at least a mass fraction of 20% of the compounds B2 are such compounds B21 which have at least one acid group that is less reactive towards isocyanate groups than the hydroxyl groups of the said compounds B21,
and in a further step, subjecting the hydroxyl group-containing polyester A and the acid groups-containing polyurethane B to a condensation step under esterifying conditions.

23. The process of claim 22 wherein the esterification reaction is conducted until the reaction product AB has an acid number of from 30 mg/g to 50 mg/g.

24. A method of use of the water-borne coating binders of claim 13 to prepare a primer-surface coating composition comprising mixing the condensation products AB with a curing agent C selected from the group consisting of capped aliphatic isocyanates and aminoplast curing agents, neutralising the resulting mixture, adding thereto at least one of fillers, wetting agents, and pigments, homogenising this mixture, and completing the coating composition by addition of further binder of claim 13, and water.
